(19) United States
(12) Patent Application Publication
(10) Pub. No.: US 2003/0063824 A1
(43) Pub. Date: Apr. 3, 2003

(54) Method and apparatus for installing bearing seals and bearing incorporating same

(76) Inventor: C. Kent Aldridge, Marion, NC (US)

Correspondence Address: Alexander M. Gerasimow, Allen-Bradley Company, LLC, 1201 South Second Street, Milwaukee, WI, 53204-2496, US

(21) Appl. No.: 09/966,487

(22) Filed: Sep. 28, 2001

(51) Int. Cl. F16C 33/76

(52) U.S. Cl. 384/477

(57) ABSTRACT

A technique is provided for securing seal to inner and outer rings of a bearing assembly. The rings present interface surfaces which may include annular grooves. The seals and rings are positioned within specialized tooling, and a portion of each seal is plastically deformed to secure the seals to the receiving rings. One or both rings may receive a seal, and the seals may include features, such as elastomeric sealing members, which cooperate to isolate interior regions of the bearing assembly from the surrounding environment.

### BACKGROUND OF THE INVENTION

The present invention relates generally to the field of bearings and bearing assemblies. More particularly, the invention relates to a technique for sealing bearing assemblies and installing seals on such assemblies to enhance retention of the seals over the life of a bearing assembly.

A wide range of bearing systems and assemblies are known and presently in use. Such bearings vary widely in configuration, depending upon the particular application, the anticipated loading, the environment in which the bearings must operate, to mention just a few factors. In general, antifriction bearings include an outer race or ring, an inner race or ring, and a series of bearing elements disposed between the races. The bearing elements may include balls, rollers, needles, tapered rollers, and so forth. Other bearing assemblies, commonly referred to as plain sleeve or journal bearings, do not include interposed bearing elements, but rely upon direct contact between inner and outer races for load bearing capabilities.

In certain environments, it is extremely useful to shield and seal the internal volumes of bearing assemblies from the surrounding environment. For example, seals are commonly used in bearing assemblies to retain lubricants within the assemblies, thereby reducing wear, lubricating the internal components, and extracting heat from the components. Seals and shields are also used to preclude the ingress of external contaminants and particles from the internal volumes of assemblies. This may be particularly useful where surrounding environments are particularly dirty, corrosive, or wet.

In the field of seal bearing assemblies, various approaches have been used for securing seals to bearing rings. In certain assemblies, the seals are installed directly on a housing that supports the bearing rings. Such seals may be clipped in place or retained via various snap-type features. Where seals are installed on bearing rings, they are typically held in place by tight or interference fits designed between portions of the seal assembly and corresponding internal or external surfaces of the bearing rings. While such attachment is often satisfactory, the seals can become damaged or loosened during use. Where seal assemblies are displaced, such as by bumping or imbalance of loading on the machine or the bearing, the seal may become an impediment to the normal functioning of the machine, or may cease to function effectively as a seal. Such retaining techniques may also be prone to damage during installation or servicing. In any of these events, the seals may require costly and time consuming repair or replacement.

There is a need, therefore, for an improved technique for attaching and securing seal assemblies to bearing components. There is a particular need for a cost-effective and reliable approach to securing one or more cooperating seal assemblies in antifriction bearings which avoids the problems of existing systems, including loosening, displacement, and damage.

### SUMMARY OF THE INVENTION

The present invention provides a novel technique for securing seals and seal assemblies in bearings designed to respond to such needs. The technique may be used in conjunction with a wide range of seal configurations and bearing assembly designs. For example, the seals may be installed on inner or outer rings, or associated components of the bearing systems. The seals may include mechanical seals, shields, elastomeric seals, supports for elastomeric seals, and so forth. In general, as used herein, the term “seal” and “seal member” may be understood broadly to include shield members, support members, and other types of seals or seal supports.

In accordance with certain aspects of the present technique, seals may be installed on both the inner and outer rings of a bearing assembly. The bearing assembly may be of any suitable type, such as an antifriction bearing including bearing components interposed between inner and outer rings. The ring or rings designed to receive the seals include an interface surface in which a groove may be formed. The seal assembly is positioned adjacent to the interface surface and is crimped or similarly plastically deformed to mount the seal assembly to the receiving ring. The technique may be performed in special tooling such that the ring, seal, and any accompanying components may simply be placed within tools or fixtures, and pressed to crimp the seal against the interface surface of the receiving ring.

In certain embodiments of the present technique, seals may be provided on both inner and outer rings of a bearing assembly. The inner and outer rings may be processed before or after assembly with one another. The seals may include features which cooperate with one another when the rings are placed in service. Thus, one or more of the seals may support an elastomeric sealing member which contacts and rides against the mating seal on the other ring. A wide range of specific designs may be envisaged, all of which may be adapted for crimped or plastically deformed fitting to the receiving ring.

### BRIEF DESCRIPTION OF THE DRAWINGS

The foregoing and other advantages and features of the invention will become apparent upon reading the following detailed description and upon reference to the drawings in which:

FIG. 1 is a sectional view through a portion of a bearing assembly illustrating the internal components of the bearing assembly and seals applied to the bearing assembly rings in accordance with the present technique;

FIG. 2 is a detailed view of a portion of the assembly of FIG. 1, illustrating in greater detail the seals and their attachment to the bearing assembly rings;

FIG. 3 is a partial sectional view of an installation system for mounting a seal to an outer ring of the type shown in FIGS. 1 and 2;

FIG. 4 is a detailed view of a portion of the installation system of FIG. 3, prior to crimping of the seal on the outer ring;

FIG. 5 is a detailed view similar to that of FIG. 4 illustrating the components of FIG. 4 following the crimping operation;

FIG. 6 is a partial sectional view of an installation system for mounting a seal to an inner ring of a bearing assembly of the type shown in FIGS. 1 and 2;

FIG. 7 is a detailed view of a portion of the system of FIG. 6 prior to crimping of the seal on the inner ring; and

FIG. 8 is a detailed view similar to that of FIG. 7 illustrating the components following the crimping operation.

### DETAILED DESCRIPTION OF SPECIFIC EMBODIMENTS

Turning now to the drawings, and referring first to FIG. 1, a bearing assembly 10 is illustrated in partial section. Bearing assembly 10 includes housing 12 in which a bearing set 14 is supported. Bearing set 14 is an antifriction bearing set, including an outer ring 16, an inner ring 18, and a series of bearing elements 20 interposed between the outer ring and the inner ring. Although a roller bearing is illustrated in FIG. 1, it should be understood that the present technique may be applied to a wide range of bearing designs and styles. Accordingly, the techniques described below may be applied to roller bearings, as well as needle bearings, ball bearings, thrust bearings, journal bearings, and so forth.

In the embodiment illustrated in FIG. 1, seals are provided on either side of the bearing set to separate an internal volume in which the bearing elements are disposed from the surrounding environment. Such separation may be useful for maintaining lubricants, both liquid and gaseous, within the internal volume and for precluding the entry into the internal volume of debris, contaminants, moisture, and so forth from the surrounding environments. As shown in FIG. 1, a first seal 22 is supported on outer ring 16. The seal 22 includes a metallic support 24 which is annular in shape, and which supports an elastomeric seal 26. A second seal 28, in the form of a “flinger,” is secured to inner ring 18. The second seal 28, in the embodiment shown, forms a shield and interacts with the elastomeric seal 26 in operation. As will be appreciated by those skilled in the art, in a common application, inner ring 18 will be caused to rotate with a supported element, such as a shaft (not shown) within the outer ring 16 in housing 12. Thus, seal 28 secured to inner ring 18 will similarly rotate, while seal 22 and its supported elastomeric seal 26 will remain stationary. Accordingly, in the embodiment shown, elastomeric seal 26 rides against both the seal 28 and against a region of the inner ring 18. Other configurations and modes of operation can, of course, be envisaged.

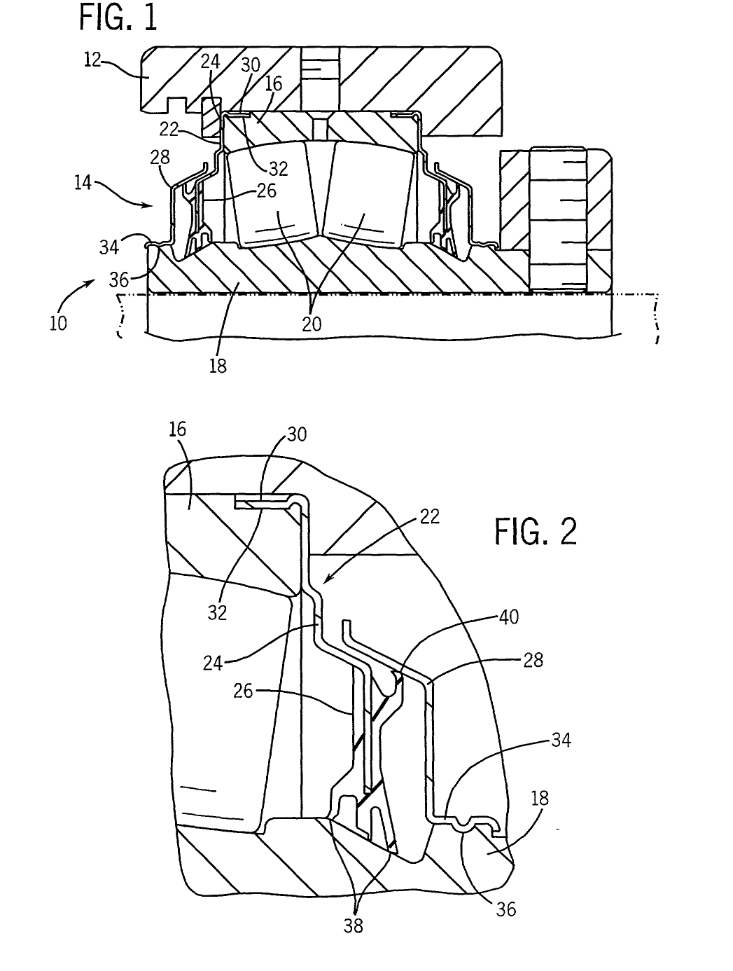

The various components and exemplary configuration of the seals shown in FIG. 1 are illustrated in somewhat greater detail in FIG. 2. As shown in FIG. 2, seal 22 is formed of a metallic support 24 which is generally annular in shape and which supports an annular elastomeric seal 26. In the illustrated embodiment, elastomeric seal 26 has several projections which ride against corresponding riding surfaces 38 and 40 of inner ring 18 and seal 28, respectively. The seals are secured to their respective rings by extensions 30 and 34, respectively. In particular, the outer ring seal 22 has an annular extension 30 which is deformed or crimped to the outer ring 16 against an interface surface 32. While any suitable interface surface 32 may be designed in a present embodiment the surface defines an annular groove about ring 16. Variations on the specific configuration of groove 32 may include dimples, ridges, and other such anti-rotation or rigidification features. Similarly, seal 28 is secured to an interface surface 36 of the inner ring 18. An extension 34, again generally annular in shape, is deformed or crimped to conform to the interface surface 36, which may be similarly grooved or otherwise contoured. As mentioned above, any suitable form of interface surface may be used for securement of the inner ring seal 28. However, in a present embodiment, an annular groove is employed.

It should be also noted that, similar or identical sealing arrangements may be provided on both sides of a bearing assembly. In the illustrated embodiment, the seal assemblies are identical to one another both on the inner and outer rings. However, different seal assemblies may be provided on either side of the bearing set, or one side of the bearing set may include seals while the opposite side is partially or completely open.

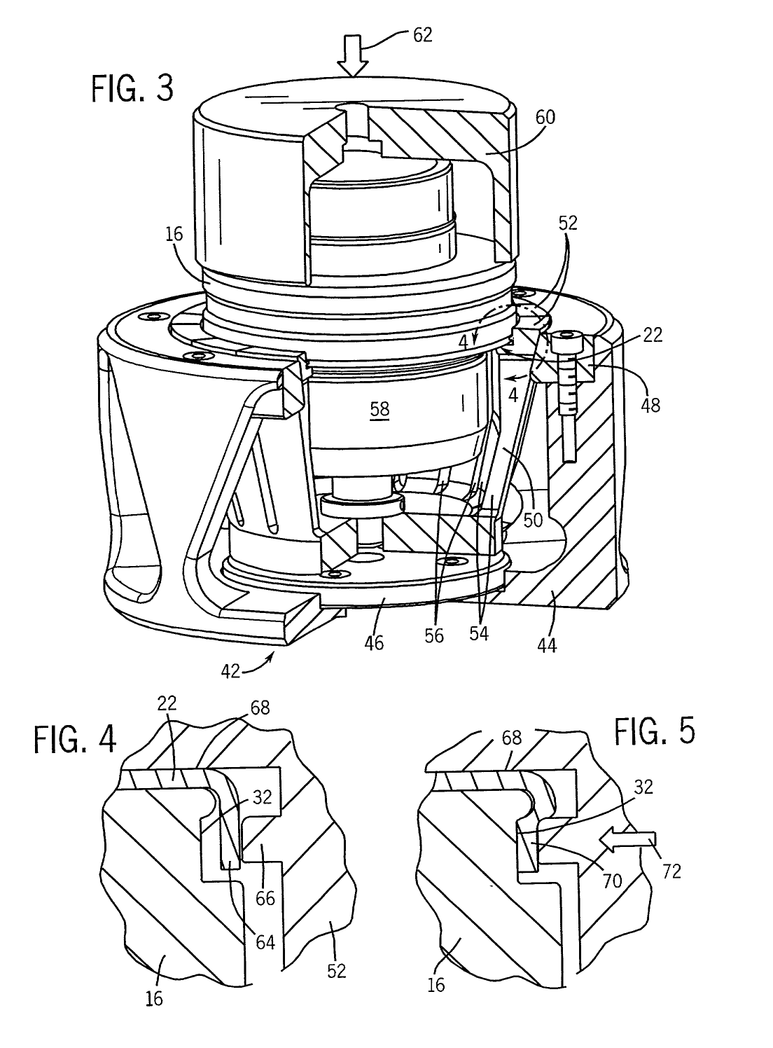

As noted above, the seals of the bearing assembly are preferably installed by plastic deformation of a portion of the seal components. In a present embodiment, the seal components include a metallic member which is crimped directly to the interface surface of the receiving ring. FIG. 3 illustrates an exemplary installation station 42 for securing a seal 22 to an outer ring 16 as described above. The system 42 illustrated in FIG. 3 is adapted for mounting in a press (not shown), such as a hydraulic press. The system includes a base or pot 44 closed at its lower end by a stop 46. The pot 44 is open at its upper end, and a tapered ring 48 is secured about the inner periphery of the upper end. A crimping collet 50 is positioned within the pot 44 and bears against the tapered ring 48.

The crimping collet 50, in the illustrated embodiment, is a single piece, metallic collet designed to contract upon entry into the tapered ring and pot, and to be released or expand for removal of the outer ring from the tool as described below. Accordingly, the crimping collet 50 includes a series of crimping sections 52 designed to be forced radially inwardly by the tapered ring during the crimping operation. Each crimping section 52 is formed at the end an elastically deformable leg 54. Slots 56 are provided between legs 54 to facilitate the radial contraction of the collet during use.

A seal support cup 58 is positioned within the collet 50 for receiving the outer ring seal 22. The seal support cup 58 thus receives and centers the outer ring seal prior to the crimping operation. An upper cup 60 serves to exert force against the bearing outer ring when positioned in the installation system.

For attachment of the outer ring seal to the outer ring, force is applied to the upper cup 60, as indicated by arrow 62 in FIG. 3. With the outer ring 16 in place within the seal 22, and with the seal centered by the seal support cup 58, the force applied to the outer ring urges the collet 50 downwardly, thereby forcing the radial contraction of the crimping section 52 by interaction with the tapered ring 48. As best shown in FIG. 4, prior to crimping, the outer ring 16 is positioned such that the uncrimped upper extension 64 of seal 22 lies in facing relation to the interface surface 32. A projection 66 of each crimping section 52 is positioned adjacent to the extension 64 of the seal. A lower support surface 68 supports the seal and ring 16. Upon downward movement of the ring and seal, and radial contraction of the collet crimping sections against the tapered ring, the projections 66 are forced inwardly to deform the extension 64, as indicated at reference numeral 70 in FIG. 5. The crimping operation is stopped upon full engagement of the crimping section and full deformation and securement of the seal as indicated by arrow 72 in FIG. 5. Thereafter, the force on the ring is released and the seal and ring are allowed to move upwardly in the view of FIG. 3, releasing the collet and freeing the outer ring and seal for removal from the installation system. Where desired, a similar seal may be applied subsequently to an opposite side of the outer ring in the same or different installation system.

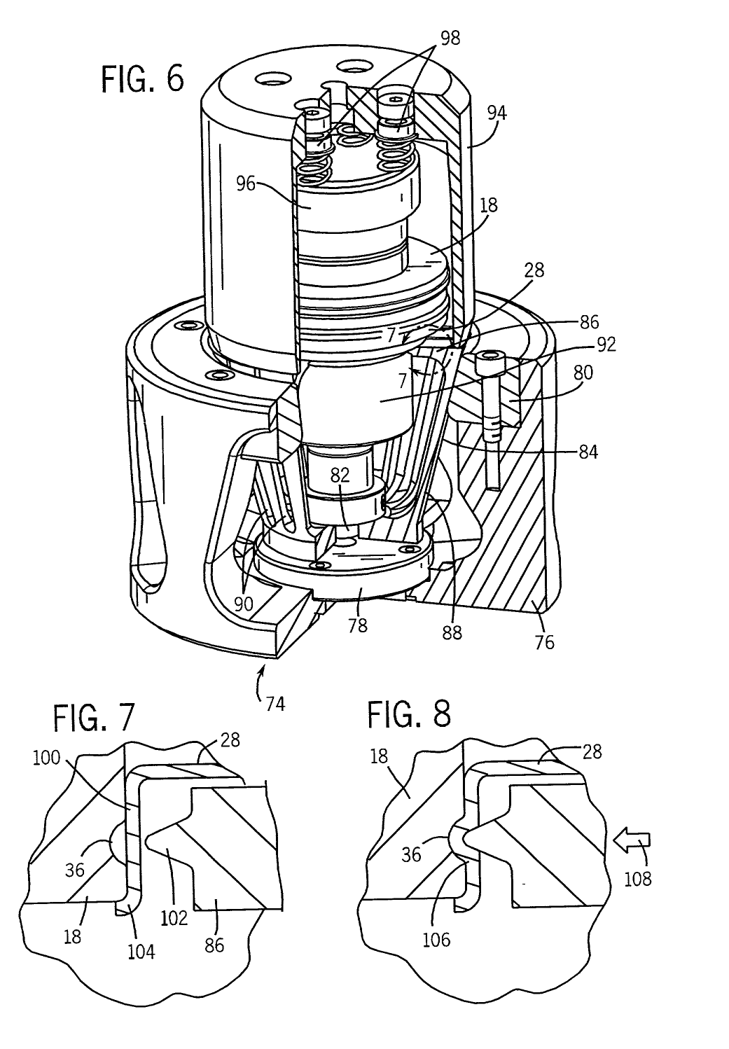

FIG. 6 represents a similar installation system 74 for securing a seal 28 to an inner ring 18. In the system of FIG. 6, a pot 76 is provided in which a stop 78 is positioned. An upper end of the pot 76 is open, with a tapered ring 80 being disposed around the inner periphery of the open upper end. A crimping collet 84 is positioned within the pot and bears against the tapered ring 80. Crimping sections 86 are formed in radial locations around the collet at upper ends of elastic legs 88. The legs are separated by slots 90 to permit the legs to be elastically contracted inwardly during the crimping operation.

A support cup 92 is provided within pot 76, and a lower pilot 82 centers the support cup within the collet. The seal 28 and inner ring 18 are positioned above the support cup 92, with the seal being centered by the support cup. An upper cup 94 is provided for exerting a force against the crimping section 86 of the collet. In the installation system of FIG. 6, a locator 96 is provided which properly aligns the inner ring 18 and seal 28. Spring biasing assemblies 98 are disposed within upper cup 94 for exerting an initial force against the locator 96 to urge the inner ring and seal into tight engagement prior to the crimping operation.

During the crimping operation, force is exerted to the upper cup to force the upper cup downwardly in the view of FIG. 6. As the upper cup descends, spring biasing assemblies 98 are compressed, appropriately locating the inner ring 18 within the inner ring seal 28 supported on the support cup 92. Once these spring assemblies are compressed and the upper cup 94 contacts the collet, the collet is urged downwardly, forcing the crimping sections 86 radially inwardly by cooperation between the collet and the tapered ring 80. As best illustrated in FIG. 7, prior to crimping, the uncrimped lower extension 100 of the inner ring seal 28 lies between the interface surface or groove 36 and a crimping projection 102 of each crimping section 86. A locating corner 104 may be provided for appropriately locating the seal and inner ring 18 with respect to one another. Following radial inward movement of the crimping sections, the projection forces plastic deformation of the seal, as indicated at reference numeral 106 of FIG. 8. Further, radial inward movement of the crimping sections, as indicated by reference numeral 108 in FIG. 8, causes the final crimping or plastic deformation of the seal extension to fix the seal to the inner ring. Upon removal of force from the upper cup, the entire assembly is free to move upwards and the ring and affixed seal are freed from the installation system. A further seal may be installed on the inner ring, where desired, in the same or different installation system.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A method for installing a seal in a bearing assembly, the method comprising the steps of:
forming an annular interface in a bearing ring;
positioning a seal member adjacent to the annular interface; and
crimping the seal member to deform a portion of the seal member into the annular interface.

2. The method of claim 1, wherein the bearing assembly includes an inner ring, an outer ring, and a plurality of bearing elements disposed between the inner and outer rings, and wherein the annular interface is formed in the outer ring.

3. The method of claim 1, wherein the bearing assembly includes an inner ring, an outer ring, and a plurality of bearing elements disposed between the inner and outer rings, and wherein the annular interface is formed in the inner ring.

4. The method of claim 1, wherein including the steps of centering the seal member in a collet and urging the bearing ring into the seal member to close the collet around the seal member.

5. The method of claim 4, wherein the collet includes a plurality of flexible fingers each terminating in a crimping head, and wherein the collet is disposed to undergo elastic deformation of the flexible fingers as the portion of the seal member is crimped into the annular groove.

6. The method of claim 1, wherein the seal member includes a flinger.

7. The method of claim 1, wherein the seal member includes an annular support ring and an elastomeric seal supported on the support ring, and wherein the portion of the seal member deformed in the crimping step is part of the support ring.

8. A method for installing a seal on a bearing assembly, the method comprising:
forming a first interface surface in an inner bearing ring and a second interface surface in an outer bearing ring;
crimping a first seal member to the first interface surface of the inner ring;
crimping a second seal member to the second interface surface of the outer ring; and
assembling the bearing assembly such that the first and second seal members cooperate with one another to seal at least a portion of the bearing assembly.

9. The method of claim 8, wherein the first interface surface includes an annular groove.

10. The method of claim 8, wherein the second interface surface includes an annular groove.

11. The method of claim 8, wherein at least one of the first and second seal members includes an elastomeric seal configured to contact the other seal member.

12. The method of claim 8, wherein at least one of the first and second seal members includes an elastomeric seal configured to contact an element of a rotational system within which the bearing assembly is placed.

13. The method of claim 8, wherein each of the crimping steps includes the steps of centering the respective seal member in a respective collet and urging the respective bearing ring into the seal member to close the collet around the seal member.

14. The method of claim 13, wherein each of the collets includes a plurality of flexible fingers each terminating in a crimping head, and wherein the collet is disposed to undergo elastic deformation of the flexible fingers as the portion of the respective seal member is crimped to the respective interface surface.

15. A method for sealing a bearing assembly, the method comprising:
forming a first interface surface in an inner bearing ring and a second interface surface in an outer bearing ring;
crimping a first seal member to the first interface surface of the inner ring;
crimping a second seal member to the second interface surface of the outer ring; and
assembling the bearing assembly such that the first and second seal members cooperate with one another to seal at least a portion of the bearing assembly;
wherein at least one of the first and second seal members includes an elastomeric seal configured to contact the other seal member when the bearing assembly is placed in service.

16. The method of claim 15, wherein the elastomeric seal is supported a support ring of the second seal member.

17. The method of claim 16, wherein a portion of the elastomeric seal is configured to contact an element of a rotating system when the bearing assembly is placed in service.

18. The method of claim 15, wherein the first interface surface includes an annular groove.

19. The method of claim 15, wherein the second interface surface includes an annular groove.

20. The method of claim 15, wherein the first seal member is crimped to the inner ring by urging the inner ring into engagement with the first seal member to force a first flexible collet to compress around the first seal member.

21. The method of claim 15, wherein the second seal member is crimped to the outer ring by urging the outer ring into engagement with the second seal member to force a second flexible collet to compress around the second seal member.

22. A bearing assembly comprising:
an inner ring;
an outer ring;
a plurality of bearing elements disposed between the inner and outer rings; and
an inner ring seal member crimped to the inner ring.

23. The bearing assembly of claim 22, wherein the inner ring seal member is crimped to an annular groove formed in an outer surface of the inner ring.

24. The bearing assembly of claim 22, further comprising an outer ring seal member crimped to the outer ring.

25. The bearing assembly of claim 24, wherein the inner ring seal member and the outer ring seal member lie in mutually facing relation in the bearing assembly.

26. The bearing assembly of claim 25, wherein an elastomeric seal extends between the inner ring seal member and the outer ring seal member.

27. A bearing assembly comprising:
an inner ring;
an outer ring;
a plurality of bearing elements disposed between the inner and outer rings; and
an outer ring seal member crimped to the outer ring.

28. The bearing assembly of claim 27, wherein the outer ring seal member is crimped to an annular groove formed in an outer surface of the outer ring.

29. The bearing assembly of claim 27, further comprising an inner ring seal member crimped to the inner ring.

30. The bearing assembly of claim 29, wherein the outer ring seal member and the inner ring seal member lie in mutually facing relation in the bearing assembly.

31. The bearing assembly of claim 29, wherein an elastomeric seal extends between the inner ring seal member and the outer ring seal member.

32. A bearing assembly comprising:
an inner ring;
an outer ring;
a plurality of bearing elements disposed between the inner and outer rings;
an outer ring seal member crimped to the outer ring; and
an inner ring seal member crimped to the inner ring.

33. The bearing assembly of claim 32, wherein the inner ring seal member and the outer ring seal member lie in mutually facing relation in the bearing assembly.

34. The bearing assembly of claim 32, further comprising an elastomeric seal extending between the inner ring seal member and the outer ring seal member.

35. The bearing assembly of claim 34, wherein the elastomeric seal member is secured to the inner ring seal member.

36. The bearing assembly of claim 32, wherein the inner ring seal member is crimped to an annular groove formed in an outer surface of the inner ring.

37. The bearing assembly of claim 32, wherein the outer ring seal member is crimped to an annular groove formed in an outer surface of the outer ring.
